(19) United States
(12) Patent Application Publication
(10) Pub. No.: US 2025/0350503 A1
(43) Pub. Date: Nov. 13, 2025

(54) DEVICES, SYSTEM, AND METHODS FOR JOINT COMMUNICATIONS AND SENSING

(71) Applicant: HUAWEI TECHNOLOGIES CO., LTD., Shenzhen (CN)

(72) Inventors: Mahdi SHAKIBA HERFEH, Boulogne Billancourt (FR); Yun Yaw CHU, Boulogne Billancourt (FR); Mohamed KAMOUN, Boulogne Billancourt (FR); Sami MEKKI, Boulogne Billancourt (FR); Stefano BUZZI, Boulogne Billancourt (FR)

(21) Appl. No.: 19/276,152

(22) Filed: Jul. 22, 2025

Related U.S. Application Data
(63) Continuation of application No. PCT/EP2023/051544, filed on Jan. 23, 2023.

(51) Int. Cl. H04L 25/02; H04W 4/38; H04W 24/08

(52) U.S. Cl. CPC H04L 25/022; H04W 4/38; H04W 24/08

(57) ABSTRACT

This disclosure relates to joint communications and sensing. A system is disclosed and comprises a first AP as a sensing AP, a second AP as a communications AP, and a network device as a controller. The communications AP and the sensing AP both receive an uplink signal from a UE. The communications AP is configured to send a processed form of the signal to the controller. The controller then provides the processed form of the signal (e.g. the decoded payload) to the sensing device. The sensing AP performs channel estimation based on the processed form of the signal and the received uplink signal. A result of the channel estimation may be provided by the sensing AP to the controller for monitoring the UE or the environment. In this way, sensing with zero wireless communications cost can be achieved.

### CROSS-REFERENCE TO RELATED APPLICATIONS

This is a continuation of International Patent Application No. PCT/EP2023/051544, filed on Jan. 23, 2023. The disclosure of the aforementioned application is hereby incorporated by reference in its entirety.

### TECHNICAL FIELD

The present disclosure relates to devices and methods in the field of wireless communications. For instance, the disclosure relates to devices and methods for joint communications and sensing.

### BACKGROUND

Recently, there has been a fast-growing interest in the field of joint communications and sensing, such as Integrated Sensing And Communication (ISAC). Both functionalities of communications and sensing utilize the same frequency resources, and common hardware and software components. The benefits of the so-called ISAC systems can range from cutting down production costs to simultaneously improving the performance by mutual assistance of radio frequency (RF) sensing and communication. For instance, the communication system can utilize the estimated location of each active User Equipment (UE) to improve the communication links (e.g., increasing signal-to-noise ratio (SNR)) by beamforming towards each UE respectively meanwhile reducing undesired interference at other users. On the other hand, RF sensors can exploit communication signaling for RF sensing under some conditions.

FIG. 6 shows an example of a distributed antenna wireless communication network. The network comprises M distributed Access Points (APs) and K active UEs (or users). The APs are spread out in a common environment and connected to a Central Process Unit (CPU) through reliable and high-capacity backhaul links. Each AP and UE can be equipped with either a single antenna or multiple antennas. In an uplink (UL) communication, an observed signal by the AP i may be denoted as:

$${y}_{i} = {\sum }_{k = 1}^{K} {h}_{ik} {x}_{k} + n ,$$

where xₖ is the transmitted signal (payload) by UE k, hᵢₖ is the channel between AP i and UE k, and n is Additive White Gaussian Noise (AWGN) with zero mean and σ² variance. For decoding the transmitted signal xₖ the AP i as a receiver needs to have Channel State Information (CSI). The receiver can obtain the CSI by receiving some pilot signals from the UEs as follows

$${y}_{i} = {\sum }_{k = 1}^{K} {h}_{ik} {p}_{k} + n ,$$

where pₖ is the pilot signal transmitted by UE k and known by both the transmitter and the receiver.

For RF sensing, some pilot signals are also used, which is similar to the pilot signals used for communications. However, the required lengths of the pilot signals are not the same for RF sensing and communications, respectively. For communications, rough channel estimation is usually enough for decoding the message. However, for RF sensing, more accurate channel estimation results in a better performance of terminal/environment sensing. Generally speaking, RF sensing requires a longer pilot signal than communications.

### SUMMARY

For joint communications and sensing, one conventional solution would be based on time/frequency/spatial division between communications and sensing. A further conventional solution would be based on mono-static sensing.

However, a problem with the time/frequency/spatial division-based solution is that wireless resources are not efficiently used. For instance, in a time division-based solution, part of time slots are assigned for sensing and no communication can occur during this period of time. This would lower the throughput of the network. This problem remains in a similar way for frequency and spatial division-based solutions.

Regarding mono-static sensing, a transmitter operates communications in a full duplex mode and performs sensing based on received echoes (of transmitted signals). In this case, communications and sensing occur at the same time and frequency. A problem with mono-static sensing is self-interference. In principle, there should be a certain level of isolation between transmitting and receiving antennas. Moreover, only the transmitter is adapted to perform sensing. That is, there is only one observation point of sensing. The accuracy of sensing is degraded.

In view of the above-mentioned problems and disadvantages, this disclosure aims to improve joint communications and sensing. For instance, an objective of this disclosure may be to increase network throughput while maintaining sensing accuracy, and vice versa. A further objective may be to (more) efficiently utilize network (wireless) resources for joint communications and sensing.

These and other objectives are achieved by the subject matter of the independent claims. Further implementation forms are apparent from the dependent claims, the description and the drawings.

A first aspect of the present disclosure provides a first AP. The first AP is configured to receive a signal from a terminal. The first AP is further configured to receive data from a network device, in which the data corresponds to a processed form of the signal. Then, the first AP is configured to perform a channel estimation based on the received signal and the data.

Optionally, the signal may be referred to as an uplink signal. The data may be referred to as a processed uplink signal. The data or the processed uplink signal may comprise any information that is obtained for decoding the uplink signal. For instance, the data may comprise one or more of a decoded message from the signal, a demodulated form of the signal, a compressed form of the signal, a digital representation of base-band representation of the signal, a probabilistic representation of the base-band representation of the signal, and a probabilistic representation of the message contained in the signal.

It is noted that the first AP may be a sensing AP. By receiving the processed uplink signal from the network device, the sensing AP may use the processed uplink signal to determine channel parameters. The determined channel parameters may be useful for sensing. For instance, the channel parameters may be further sent to the network device, such that the network device can monitor the terminal or environment. In this way, sensing with zero wireless communication cost can be achieved due to re-using of the uplink signal.

In an implementation form of the first aspect, the result of the channel estimation may comprise channel response information (CSI).

Optionally, the first AP may be adapted to perform sensing based on the result of the channel estimation.

A second aspect of the present disclosure provides a network device. The network device is configured to obtain data. The data corresponds to a processed form of a signal that is transmitted by a terminal and is received by the one or more second APs. The one or more second APs are for communications (or have communications capabilities). Then, the network device is configured to send the data to one or more first AP for sensing.

It is noted that “the processed form of the signal that is transmitted by the terminal and is received by the one or more second APs” may simply be referred to as a processed uplink signal.

By sending the processed uplink signal to the one or more sensing APs, the uplink signal can be re-used for sensing. Thus, sensing with zero wireless communication cost can be achieved.

In a further implementation form of the second aspect, the network device may be configured to obtain the data by receiving the data from the one or more second APs. The data may correspond to a decoded payload of the signal.

It is noted that in this case, the one or more second APs (as communications AP) have decoding capability.

In a further implementation form of the second aspect, the network device may be configured to obtain the data by receiving the signal or a pre-processed signal from each second AP, and decoding a payload from the signal or the pre-processed signal to obtain the data.

It is noted that in this case, the one or more second APs (as communications APs) may not have decoding capability. Hence, decoding of the uplink signal is performed at the network device side.

In a further implementation form of the second aspect, the network device may be configured to send the data to the one or more first APs by sending a part of the data to the one or more first APs according to one or more of a sensing requirement, traffic information, and a memory constraint of the one or more first APs.

A third aspect of the present disclosure provides a system for sensing and communications. The system comprises a network device, one or more first APs for sensing, and one or more second APs for communications. The network device is configured to obtain data, in which the data corresponds to a processed form of a signal. The signal is transmitted by a terminal and is received by the one or more second APs. The network device is configured to send the data to the one or more first APs. Each first AP is configured to receive the signal from the terminal, receive the data from the network device, and perform a channel estimation based on the received signal and the data.

Optionally, the signal may be referred to as an uplink signal. The processed form of the signal may be referred to as a processed uplink signal. In contrast, the uplink signal that is not processed may be referred to as a raw uplink signal.

Optionally, the raw uplink signal may be processed by a respective second AP, or by the network device, or by both the respective second AP and the network device.

In this way, sensing with zero wireless communication cost can be achieved. Because the uplink signal can be re-used for sensing. There is no need to additionally use a different or separate signal for sensing.

In an implementation form of the third aspect, the processed form of the signal may comprise one or more of a decoded message from the signal, a demodulated form of the signal, a compressed form of the signal, a digital representation of base-band representation of the signal, a probabilistic representation of the base-band representation of the signal, and a probabilistic representation of the message contained in the signal.

In a further implementation form of the third aspect, each first AP may be further configured to perform sensing based on a result of the channel estimation.

In a further implementation form of the third aspect, each first AP may be further configured to send a result of the channel estimation to the network device. The network device may be further configured to receive one or more results of the channel estimation from the one or more first APs, and perform sensing based on the one or more results of the channel estimation.

When there are multiple first APs, multiple observation points can be provided for sensing. In this way, the accuracy of sensing can be improved.

In a further implementation form of the third aspect, at least a part of the one or more second APs may be further configured to function as a part of the one or more first APs.

Optionally, the one or more second APs may be a subset of the one or more first APs.

In a further implementation form of the third aspect, each second AP may be configured to pre-process the received signal and send the pre-processed signal to the network device. The network device may be configured to obtain the data by receiving the pre-processed signal from the one or more second APs.

In a further implementation form of the third aspect, the network device may be configured to obtain the data by:
receiving, from each second AP, the signal or the pre-processed signal; and
decoding a payload from the signal or the pre-processed signal, to obtain the data.

In a further implementation form of the third aspect, the result of the channel estimation may comprise CSI.

In a further implementation form of the third aspect, the network device may be configured to send the data to the one or more first APs by sending at least a part of the data to the one or more first APs according to one or more of a sensing requirement, traffic information, and a memory constraint of the one or more first APs.

A fourth aspect of the present disclosure provides a method comprising the following steps:
receiving, by a first AP, a signal from a terminal;
receiving, by the first AP, data from a network device, wherein the data corresponds to a processed form of the signal; and
performing, by the first AP, a channel estimation based on the received signal and the data.

A fifth aspect of the present disclosure provides a method comprising the following steps:
obtaining, by a network device, data, wherein the data corresponds to a processed form of a signal that is transmitted by a terminal and received by one or more second APs for communications; and
sending, by the network device, the data to one or more first APs for sensing.

A sixth aspect of the present disclosure provides a method for sensing and communications. The method comprises the following steps:
obtaining, by a network device, data, wherein the data corresponds to a processed form of a signal that is transmitted by a terminal and received by one or more second APs for communications;
sending, by the network device, the data to one or more first APs for sensing;
receiving, by each first AP, the signal from the terminal;
receiving, by each first AP, the data from the network device; and
performing, by each first AP, a channel estimation based on the received signal and the data.

In an implementation form of the sixth aspect, the processed form of the signal may comprise one or more of a decoded message from the signal, a demodulated form of the signal, a compressed form of the signal, a digital representation of base-band representation of the signal, a probabilistic representation of the base-band representation of the signal, and a probabilistic representation of the message contained in the signal.

In a further implementation form of the sixth aspect, the method may further comprise performing, by each first AP, sensing based on a result of the channel estimation.

In a further implementation form of the sixth aspect, the method may further comprise:
sending, by each first AP, a result of the channel estimation to the network device;
receiving, by the network device, one or more results of the channel estimation from the one or more first APs, and
performing, by the network device, sensing based on the one or more results of the channel estimation.

In a further implementation form of the sixth aspect, at least a part of the one or more second APs may be further configured to function as a part of the one or more first APs.

Optionally, the one or more second APs may be a subset of the one or more first APs.

In a further implementation form of the sixth aspect, the method may further comprise:
pre-processing, by each second AP, the received signal;
sending, by each second AP, the pre-processed signal to the network device;
obtaining, by the network device, the data by receiving the pre-processed signal from the one or more second APs.

In a further implementation form of the sixth aspect, the network device may be configured to obtain the data by:
receiving, from each second AP, the signal or a pre-processed signal; and
decoding a payload from the signal or the pre-processed signal, to obtain the data.

In a further implementation form of the sixth aspect, the result of the channel estimation may comprise CSI.

In a further implementation form of the sixth aspect, the network device may be configured to send the data to the one or more first APs by sending at least a part of the data to the one or more first APs according to one or more of a sensing requirement, traffic information, and a memory constraint of the one or more first APs.

The method of the sixth aspect and its implementation forms may share the same features and advantages as the system of the third aspect and implementation forms thereof.

A seventh aspect of the present disclosure provides a computer program comprising instructions which, when the program is executed by a first computer, cause the first computer to perform the method according to the fourth aspect or any implementation forms thereof.

An eighth aspect of the present disclosure provides a computer program comprising instructions which, when the program is executed by a second computer, cause the second computer to perform the method according to the fifth aspect or any implementation forms thereof.

A ninth aspect of the present disclosure provides a computer-readable medium comprising instructions which, when executed by a first computer, cause the first computer to carry out the method according to the fourth aspect or any implementation form thereof.

A tenth aspect of the present disclosure provides a computer-readable medium comprising instructions which, when executed by a second computer, cause the second computer to carry out the method according to the fifth aspect or any implementation form thereof.

An eleventh aspect of the present disclosure provides a first chipset comprising instructions which, when executed by the first chipset, cause the first chipset to carry out the method according to the fourth aspect or any implementation form thereof.

A twelfth aspect of the present disclosure provides a second chipset comprising instructions which, when executed by the second chipset, cause the second chipset to carry out the method according to the fifth aspect or any implementation form thereof.

It has to be noted that all devices, terminals, elements, units, and means described in the present application could be implemented in software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description, a specific functionality or step to be performed by external entities is not reflected in the description of a specific detailed element of that entity, which performs that specific step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms will be explained in the following description in relation to the enclosed drawings, in which

FIG. 1 shows a system for communications and sensing according to this disclosure;

FIG. 2 shows a signaling diagram of an uplink framework according to this disclosure;

FIG. 3 shows an example of a flow chart according to this disclosure;

FIG. 4 shows an example of a system according to this disclosure;

FIG. 5 shows a diagram of a method according to this disclosure; and

FIG. 6 shows an example of a distributed antenna network structure.

### DETAILED DESCRIPTION OF EMBODIMENTS

The present disclosure considers an application scenario where K active UEs perform uplink communications with a system comprising M distributed antenna nodes. K and M are positive integers and M is larger than one. The system may be a distributed antenna system (DAS), a distributed antenna network (DAN), or a cell-free system. The antenna node may be also known as an AP, RF node, antenna unit, or remote radio head (RRH).

The system may be adapted for integrated sensing and communications (ISAC). The M distributed antenna nodes of the system are manageable by a controller unit. Since the system has a distributed antenna structure, users can experience a more homogeneous quality of service. Therefore, the system is promising for communications. An antenna node that can be adapted to provide communications may be referred to as a communications AP. On the other hand, the expected distance between the closest antenna nodes to the UEs of the system is significantly low (e.g., lower than conventional cellular networks), which may lead to a better channel estimation. Further, each UE regularly can experience a fairly good channel state with multiple antenna nodes at the same time. This may provide multiple observation points for sensing. Thus, the system is also promising for sensing. An antenna node that can be adapted to perform sensing may be referred to as a sensing AP. It is noted that a single antenna node may be adapted to perform both sensing and communications (or the single antenna node may have both sensing and communications capabilities).

Generally, this disclosure proposes an uplink framework, which can enable one or more APs to perform sensing based on data (payload) transmissions with no extra wireless resource allocation. This can be achieved by providing a processed uplink signal(s) (for example but not limited to: decoded data payload) by a network controller to the one or more sensing APs through backhaul links. After receiving the processed uplink signal(s), the one or more sensing APs may consider the corresponding data payload transmission(s) as a pilot signal(s) and perform channel parameter estimation (e.g., in order to determine delay, doppler frequency shift, and the angle of arrival). Providing sensing capability with zero extra wireless resources is beneficial since the wireless resources are limited and valuable.

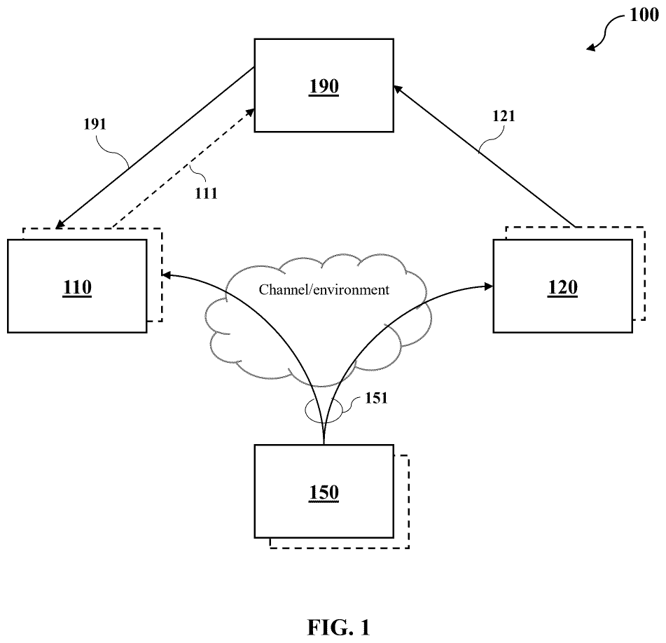

In FIGS. 1-6 below, corresponding elements may share the same features and may function likewise.

FIG. 1 shows a system 100 for communications and sensing according to this disclosure. The system 100 comprises one or more first APs 110 for sensing, one or more second APs 120 for communications, and a network device 190. For the sake of readability, in the present disclosure: a first AP for sensing may be referred to as a sensing AP 110; a second AP for communications may be referred to as a communications AP (or comm. AP) 120; and the network device 190 may be referred to as a controller unit (or simply a controller) 190. Optionally, the system 100 may be a DAS. In FIG. 1, one sensing AP 110 and one communications AP are exemplarily shown. There may be multiple sensing APs and/or multiple communications APs in the system 100.

The controller 190 is configured to obtain data 191. The data 191 corresponds to a processed form 121 of an (uplink) signal 151. The signal 151 is transmitted by a terminal (or UE) 150 and is received by the communications AP 120. For instance, the signal 151 may be seen as a raw uplink signal. In contrast, the data 191 may be a processed form 121 of the raw uplink signal 151. Then, the controller 190 is configured to send the data 191 to the sensing AP 110.

The sensing AP 110 is configured to receive the signal 151 from the UE 150, and receive the data 191 from the controller 190. Then, the sensing AP 110 is configured to perform a channel estimation based on the received signal 151 and the data 191.

It is noted that optionally (or in alternative to performing the channel estimation), the sensing AP 110 may be configured to perform sensing (or one or more sensing-related tasks) based on the received signal 151 and the data 191. For instance, based on the received signal 151 and the data 191, the sensing AP 110 may infer or estimate location(s) of a device (e.g., the UE 150) and/or obstacle(s). For obstacle(s), the size of the obstacle(s) may also be inferred. In this case, performing channel estimation is not necessary for the sensing AP 110. If the channel estimation is performed, the result of the channel estimation (e.g., CSI) can be additionally used for performing sensing.

Optionally, the communications AP 120 may be further configured to at least partly decode the signal 151 received from the UE 150. During the decoding of the signal 151, various intermediate information may be obtained by the communications AP 120. The data 191 may comprise any information that can be processed from the signal 151 in order to decode a data payload (or message) from the signal 151. Hence, the data 191 corresponds to a processed form 121 of the signal 151.

For instance, the communications AP 120 may be configured to process the signal 151 to obtain a first processed form 121 of the signal 151. The first processed form 121 of the signal 151 is then sent by the communications AP to the controller 190.

Optionally, the communications AP may be configured to forward the first processed form 121 of the signal 151 as the data 191 to the sensing AP 110. In this case, the first processed form may be, for example but not limited to, any one of: a decoded message (or decoded payload) of the signal, a demodulated form of the signal, a compressed form of the signal, a digital representation of base-band representation of the signal, a probabilistic representation of the base-band representation of the signal, and a probabilistic representation of the message contained in the signal. Alternatively, the communications AP may be further configured to process (e.g., at least partly decode) the first processed form 121 of the signal 151, to obtain a second processed form of the signal 151. In this case, the controller 190 is configured to send the second processed form of the signal 151 as the data 191 to the sensing AP. The second processed form may be, for example but not limited to, any one of: a decoded message (or decoded payload) of the signal, a demodulated form of the signal, a compressed form of the signal, a digital representation of base-band representation of the signal, a probabilistic representation of the base-band representation of the signal, and a probabilistic representation of the message contained in the signal.

Generally, at least one of the controller 190 and the communications AP 120 shall be configured to process the signal 151 in order to obtain the data 191, which is sent to the sensing AP 110 by the controller 190. The data 191 can be a processed form of the signal 151 that is processed by the communications AP 120, or by the controller 190, or by both the communications AP 120 and the controller 190.

Optionally, the communications AP 120 may be configured to send a part of the processed form of the signal 151 as the data 191 to the sensing AP 110. This is because for sensing, it may not be needed to have a complete processed form of the signal 151. A part of the processed form of the signal 151 may be sufficient for sensing. In this way, communication costs on the backhaul link(s) can be further reduced.

Optionally, when there are multiple communications APs receiving the same signal 151 from the UE, each communications AP may provide a respective processed form of the signal 151. The respective processed forms from the multiple communications APs may be the same or different. The controller is configured to obtain the data 191, which may comprise multiple processed forms 121 of the signal 151, from the multiple communications APs.

Optionally, the data 121 may comprise one or more of a demodulated form of the signal 151, a compressed form of the signal 151, a digital representation of base-band representation of the signal 151, a probabilistic representation of the base-band representation of the signal 151, a probabilistic representation of the message contained in the signal 151, and even a decoded message from the signal 151.

Optionally, the decoding of the signal 151 may be performed by the controller 190. To this end, the controller 190 may be configured to receive the signal 151 and/or the processed form 121 of the signal 151 from the communications AP 120, and decode from the signal 151 and/or the processed form 121 of the signal 151, to obtain the data 191. Then, the controller 190 is configured to send the data 191 to the sensing AP 110.

Optionally, the sensing AP 110 may be further configured to perform sensing based on the result of the channel estimation. The sensing AP 110 may be further configured to send the result of the channel estimation to the communications AP 120, e.g., via the controller 190. The communications AP 120 may be further configured to optimize its communications with the UE 150 based on the result of the sensing. Optionally, the result of the channel estimation may comprise CSI.

Optionally or alternatively, the sensing may be performed at the controller 190 (in addition to or in alternative to performing sensing at the sensing AP 110). For instance, the sensing AP 110 may be further configured to send the result 111 of the channel estimation (e.g., CSI) to the controller 190. The controller 190 may be further configured to receive the result 111 of the channel estimation and perform sensing based thereon. When there are multiple sensing APs providing the result 111 of the channel estimation respectively to the controller 190, the controller may be adapted to perform sensing based on the multiple channel estimation results combinedly. In this way, multiple observation points are exploited for sensing the terminal and the performance of the sensing (e.g. accuracy) can be improved.

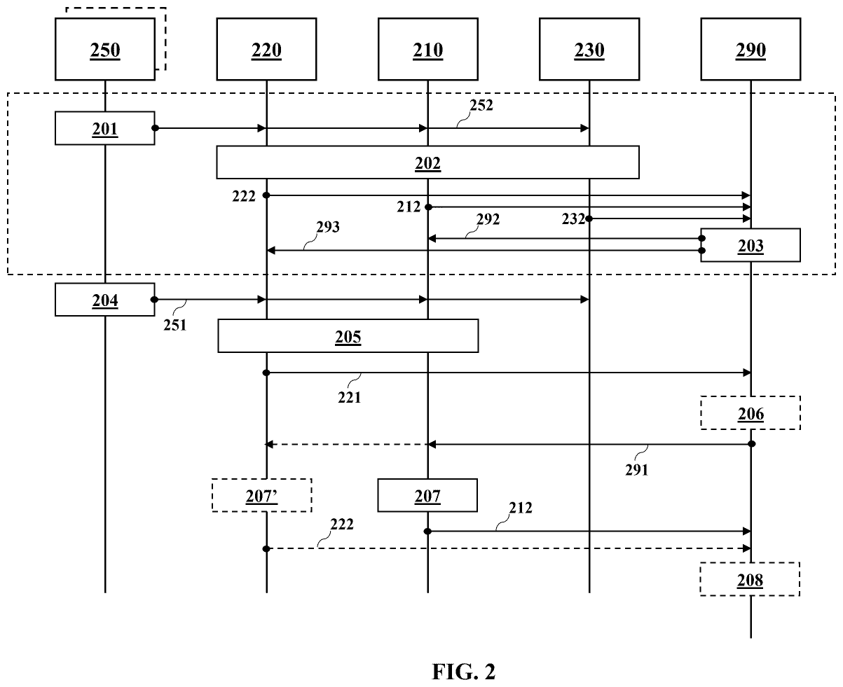

FIG. 2 shows a signaling diagram of an uplink framework according to this disclosure. The signaling diagram depicts an example of signal flows for a system that corresponds to the system 100 of FIG. 1. Similarly, the system of FIG. 2 comprises a terminal (or UE) 250, at least one sensing AP 210, at least one communications AP 220, and a controller 290. A further AP 230 is illustrated only for comparison, and the further AP 230 is not a necessary element for this disclosure. Corresponding elements in FIG. 1 and FIG. 2 may share the same features or function likewise.

The signaling may comprise the following steps 201-208.

Step 201: The UE 250 sends its pilot signal(s) 252 to multiple distributed APs 210, 220, 230 in the system.

Step 202: Each AP 210, 220, 230 receiving the pilot signal(s) measures its channel with the UE 250 and sends respective channel information 212, 222, 232 to the controller 290 through backhaul links. Optionally, in alternative to sending channel information to the controller 290, one or more of the APs 210, 220, 230 may be configured to send a processed form of the pilot signal(s) to the controller 290.

Step 203: The controller 290 determines one or more APs for conducting the communication, which may be referred to as a communications set. The controller 290 may determine the communications set based on channel conditions, communication requirements, and other factors such as traffic status of each AP. Furthermore, the controller 290 also determines one or more APs for sensing, which may be referred to as a sensing set. The two communication and sensing sets may have common elements. That is, one certain sensing AP may also function as a communications AP. In some optional cases, the communications set may be a subset of sensing set. This may be due to the fact that the APs that are conducting communications normally should have a good channel condition as well. The controller 290 announces the communication and sensing sets through the backhaul links. In FIG. 2, AP 220 is selected as a sensing and communications AP, and AP 210 is selected as sensing only AP. Thus, the controller 290 may send notifications 292, 293 accordingly. AP 230 is selected neither for communications nor for sensing. Therefore, the controller 290 send nothing to AP 230. Alternatively, the controller 290 may broadcast the communications set and the sensing set in the system and an AP may determine whether it is selected for communications and/or sensing. It is noted that AP 220 selected for both communications and sensing does not contradict its role as a communications AP. Any AP capable of communications may be called a communications AP. Any AP capable of sensing may be called a sensing AP. The tasks of communications and sensing do not contradict and can be performed by a single AP.

It is further noted that the above steps 201-203 are not necessary and are entirely optional for this disclosure. The above steps 201-203 are not needed to be performed every time. For instance, when the controller 290 already has knowledge/information on the channel condition of each AP, e.g. through history or previous communications and channel estimations, it is not necessary for the APs to perform another round of pilot-based channel estimation. For another example, the pilot-based channel estimation may be performed once and the channel information collected by the controller 290 may be stored and used for further use. Hence, steps 201, 202 and 203 are optional.

Step 204: The UE performs uplink transmissions and sends a signal 251 in the system. The APs in the system form a distributed antenna structure, and each AP may have the capability of receiving the signal 251 (when radio condition allows it).

Step 205: Any AP in the sensing set (i.e. a sensing AP) is configured to record received signal from the UE 210. That is, in the example of FIG. 2, AP 210 and AP 220 record their received signals, which may be denoted as Y_1 and Y_2. AP 230, which is not a sensing AP, does not record the signal. Any AP in the communication set (i.e. a communications AP) may be configured to pre-process the received signal and send the processed signal to the controller. Pre-processing the signal may be any one or more steps of multiple steps for decoding a data payload from the signal. The multiple steps may comprise but not limited to: noise reduction, demodulation, Analog/Digital (A/D) conversion, channel decoding, source decoding, D/A conversion. That is, in the example of FIG. 2, AP 220 sends a processed form 221 of the signal to the controller 290, e.g. through the backhaul links. From the controller's 290 point of view, the controller 290 simply receives data 221 from the communications AP 220. The data corresponds to a processed form of the signal 251.

Step 206: The controller 290 may be adapted to decode the signal. For instance, the controller 290 may decode the signal based on the processed form of the signal using channel information between AP 220 and UE 250. Since the controller may be seen as a management unit of the system, the channel information may be either available to it in advance or obtained through step 202 mentioned above. As a result, a decoded payload 291 of the signal 251 may be obtained by the controller 209. The controller 209 may be configured to send the decoded payload 291 to the sensing AP 210. Optionally, the decoded payload 291 may also be provided to AP 220. Generally, in this step, the controller 290 may be adapted to decode the payload from the received processed signal 221 by any one or more APs in the communication set, and to distribute the decoded payload 291 to any one or more APs in the sensing set. The decoded payload 291 may be denoted as X_est.

It is noted that step 206 is entirely optional. The controller 290 is not necessarily configured to decode the signal based on the processed form of the signal. Instead, the controller 290 may be configured to provide the processed form of the signal 251 to any one or more APs in the sensing set. Alternatively, the controller 290 may be configured to process the processed signal 221 received from the AP 220, to obtain a further processed signal. Then, the controller 290 may be configured to provide the further processed signal to any one or more APs in the sensing set (e.g., AP 210).

It is noted that the decoded payload 291 may also be seen as an example of the processed form of the signal 251. Therefore, generally, a sensing AP (e.g. AP 210) is adapted to receive a processed form of the signal from the controller 290.

Step 207 (207′): Any one or more APs in the sensing set, after receiving the decoded payload (or the processed form) of the signal 251 from the controller 290, perform channel estimation. For example, channel parameters (or channel information) (e.g., delay, doppler frequency shift, and the angle of arrival) of each transmission path may be calculated. For instance, based on the recorded signal Y_1 and the decoded payload X_est, CSI may be determined by AP 210. The same applies to AP 220 based on Y_1 and X_est. Then, the one or more APs send the estimated channel parameters to the controller 290 through the backhaul links. In the example of FIG. 2, AP 210 and AP 220 send estimated channel parameters 212, 222 to the controller 290. Optionally, a sensing result may be determined by a sensing AP itself based on the estimated channel parameters. In this case, the sensing AP may be configured to provide the sensing result to the controller 290.

Step 208: The controller 290, after gathering the estimated channel parameters from each sensing AP, may be adapted to perform sensing. For instance, the controller 290 may analyze the estimated channel parameters in order to monitor the UE or the environment. Optionally, when the controller 290 receives a sensing result from a sensing AP, the controller may consider the sensing result as a possible observation point for monitoring UE or the environment.

The above steps 201-208 are possible examples of the uplink framework. In the case of multiple UEs, the steps 201-208 of FIG. 2 may have the following variation.

(Optional) Step 201-A: Multiple UEs send pilot signals 252 in an orthogonal time, frequency, or code domain to multiple distributed APs 210, 220, 230.

(Optional) Step 202-A: The APs 210, 220, 230 measures their channels with the UEs respectively and send their channel information 212, 222, 232 to the controller 290 through the backhaul links. It is noted that each UE and AP pair may correspond to a piece of respective channel information.

(Optional) Step 203-A: The controller 290 determines, for each UE, particular communications set and a particular sensing set, similar to the step 203 mentioned above.

Step 204-A: Each UE performs uplink transmissions and sends its own signal 251, similar to the step 204 mentioned above.

Step 205-A: Similar to the step 205 mentioned above: any sensing AP 210, 220 records receive signals. Any communications AP 220 sends a processed form 221 of each signal to the controller 290. Recorded signals at AP 210 and AP 220 may be denoted as Y_11, Y_12, Y_21, Y_22, which may represent signals sent by UE 1 and UE 2 received by AP 210 and AP 220, respectively.

Step 206-A: Similar to the step 206 mentioned above, the controller 290 may be optionally configured to decode payloads from the received processed signal by the APs in the communication sets. The controller 290 is configured to distribute the processed form (or the decoded payload) of each signal to the APs in the sensing sets.

Step 207-A: Similar to the step 207 mentioned above, any one or more APs in the sensing set may be configured to perform channel estimation.

Step 208-A: similar to step 208 mentioned above.

Optionally, one or more APs in the system may have decoding capability. In this case, the above-mentioned steps 205 (including 205-A) and 206 (including 206-A) may have the following variation.

Step 205-B: Each AP having decoding capability in the communications set (e.g. AP 220 in FIG. 2) may be configured to decode the received signal to obtain a decoded payload 221. Optionally, multiple APs in the communications set may be configured to cooperatively decode (e.g., through partial decoding or iterative decoding) the payload from the signal (not shown in FIG. 2). For instance, each communications AP may be adapted to decode at least a part of the payload of the signal and provide the decoded part to the controller.

Step 206-B: The controller 290 may be configured to distribute the decoded payload 291 in the sensing set. When a part of decoded payloads are received from multiple communications APs, the controller 290 may be configured to combine the multiple partial decoded payloads to obtain a complete decoded payload.

Other steps may share the same features as mentioned above.

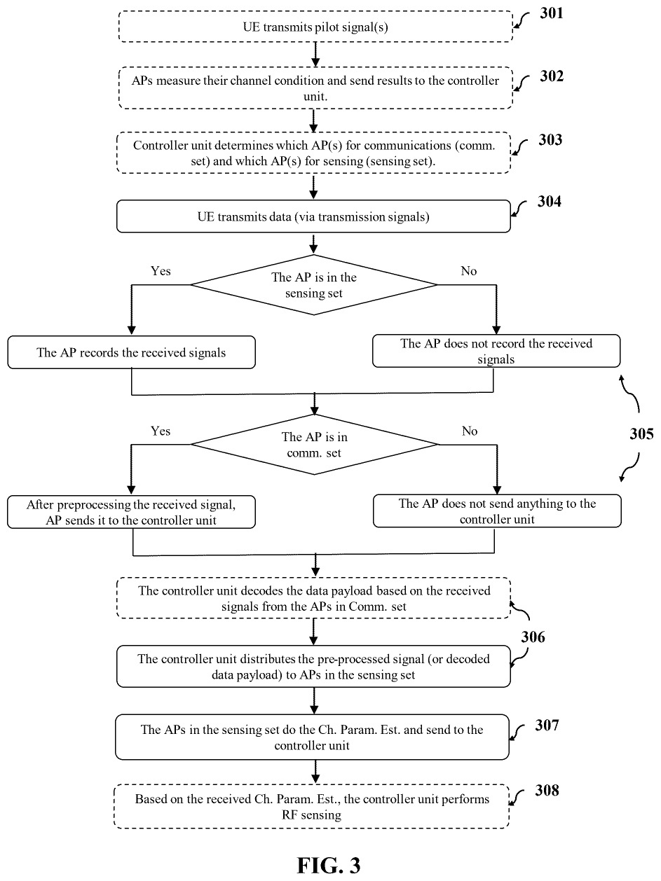

FIG. 3 shows an example of a flow chart according to this disclosure. Steps 301-308 of the flow chart may share the same features as steps 201-208 (including their variations) mentioned above. Therefore, details are not repeated herein again.

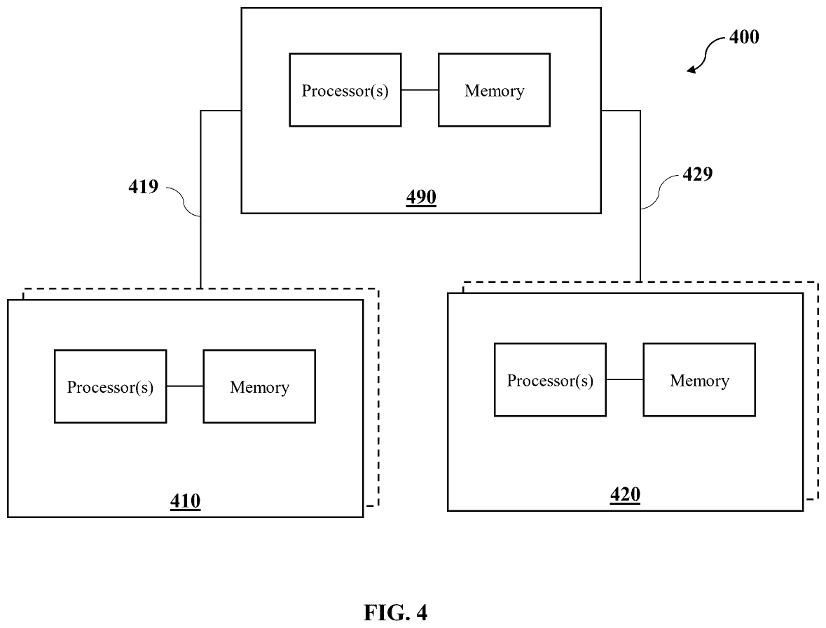

FIG. 4 shows an example of a system 400 according to this disclosure. The system 400 may be built based on the system 100 of FIG. 1 and/or based on the system of FIG. 2. The system 400 comprises a first AP 410, a second AP 420, and a network device (controller) 490. As illustrated in FIG. 4, each device 410, 420, 490 may comprise one or more processors and a memory. The memory is connected to the one or more processors and may carry executable program code which, when executed by the one or more processors, causes the device to perform, conduct or initiate the operations or steps described in this disclosure, respectively.

It is noted that FIG. 4 merely provides a schematic diagram of possible hardware structures of the first AP, the second AP, and the network device according to this disclosure. These devices may have more or fewer parts than those shown in FIG. 4, or may have different part configurations or settings. For instance, a transceiver unit may be optionally and additionally included in the first AP, the second AP, and the network device, respectively.

Optionally, each AP 410, 420 may be connectable with the controller 490 via backhaul links 419, 429, respectively. The backhaul links may be relatively reliable and of high capacity (in view of wireless channels between an AP and a UE). Optionally, signal(s) transferred in the backhaul links 419, 429 may be digital, analog, or in a combination (or hybrid) of both digital and analog.

In order to reduce added traffic to the backhaul links 419, 429 due to the exchange of the processed form of uplink signals via the backhaul links 419, 429, the controller 490 may be adapted to send a part of the processed form (or decoded payload) of the signal to a sensing AP through the respective backhaul link.

For instance, if the network needs to exploit a portion of data payload for sensing due to it satisfies the sensing constraints, the controller 490 may be configured to decide on a part of a processed signal (or the decoded payload) that is going to be exploited for sensing, e.g. based on sensing constraints and channel information of the APs. The controller 490 informs the APs in the sensing set that only a part of the processed signal (or the decoded payload) is to be sent. Then, the controller 490 only distributes that part of the processed signal (or the decoded payload) to the sensing AP(s). This is a tradeoff to reduce the added traffic to the backhaul links with the cost of dismissing part of the processed signal (or the decoded payload) for sensing. The amount of data payload which is distributed to the APs in the sensing set can be optimized based on sensing requirements and traffic status in the backhaul link.

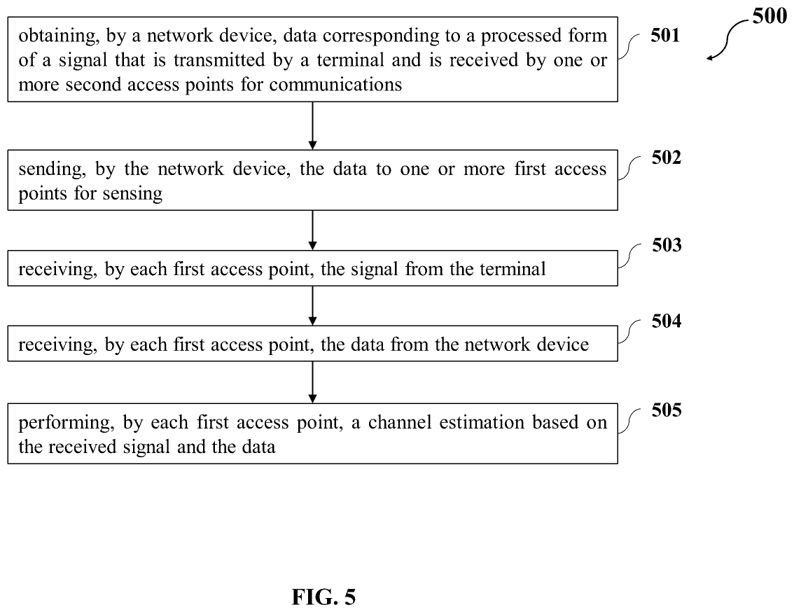

FIG. 5 shows a diagram of a method 500 according to this disclosure.

The method 500 comprises the following steps:
step 501: obtaining, by a network device, data corresponding to a signal that is transmitted by a terminal and is received by one or more second APs for communications;
step 502: sending, by the network device, the data to one or more first APs for sensing;
step 503: receiving, by each first AP, the signal from the terminal;
step 504: receiving, by each first AP, the data from the network device; and
step 505: performing, by each first AP, a channel estimation based on the received signal and the data.

It is noted that the steps of method 500 may share the same functions and details from the perspective of FIGS. 1-4 described above.

In summary, the present disclosure provides a framework (or a protocol) between a controller and APs in that:
assigning by the controller communications and sensing tasks to respective sets of APs based on channel conditions and the like;
providing, by communications AP(s), processed uplink signal (or decoded payload of the uplink signal) to the controller through backhaul links.
distributing by the controller the processed uplink signal (or the decoded payload) to sensing AP(s) through backhaul links; and
sending, by the sensing AP(s), channel estimated parameters to the controller.

In this way, sensing with zero wireless communication cost can be achieved. Moreover, when there are multiple communications APs and/or multiple sensing APs, multiple observation points can be provided for sensing. The accuracy of the sensing can be further increased.

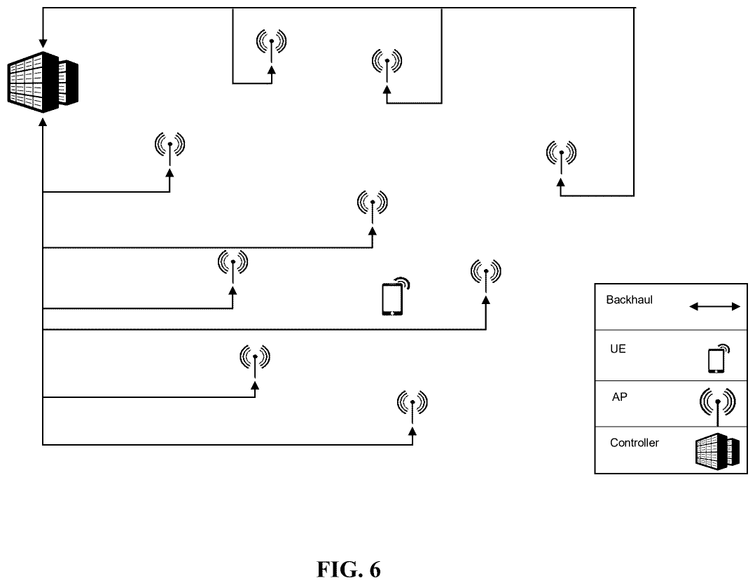

FIG. 6 shows an example of a distributed antenna network structure. Each system disclosed with respect to FIGS. 1-5 may be based on the distributed antenna network structure.

The distributed antenna network comprises a controller (or a central server), and multiple APs. A UE may be adapted to communicate with the multiple APs at the same time, e.g., through multiple-input-multiple-output (MIMO) technology.

The present disclosure may be applied to any communications network that has a similar structure as the distributed antenna network. For instance, the present disclosure may be applied to a vehicle-to-everything (V2X) network. The APs may be roadside units (RSUs). A vehicle or a communications component of the vehicle may be considered as the UE. For a further example, the present disclosure may be applied to a internet-of-things (IoT) network, such as an Industry 4.0 network where multiple sensors/transceivers are distributed in a factory and a mobile robot therein can be seen as a UE. The present disclosure can also be applied to a massive MIMO system.

It is further noted that the present disclosure can not only be applied to uplink transmission, but also be applied to other transmissions such as sidelink transmission or device-to-device (D2D) transmission. In a sidelink transmission, each sidelink UE may be adapted to function as an AP of this disclosure, and a communications UE may be adapted to function as the UE of this disclosure.

It is noted that the devices (i.e., the first AP, the second AP, and the network device) in the present disclosure may comprise processing circuitry configured to perform, conduct or initiate the various operations of the device described herein, respectively. The processing circuitry may comprise hardware and software. The hardware may comprise analog circuitry or digital circuitry, or both analog and digital circuitry. The digital circuitry may comprise components such as application-specific integrated circuits (ASICs), field-programmable gate arrays (FPGAs), digital signal processors (DSPs), or multi-purpose processors. Optionally, the processing circuitry comprises one or more processors and a non-transitory memory connected to the one or more processors. The non-transitory memory may carry executable program code which, when executed by the one or more processors, causes the device to perform, conduct or initiate the operations or methods described herein, respectively.

The present disclosure has been described in conjunction with various aspects as examples as well as implementations. However, other variations can be understood and effected by those persons skilled in the art and practicing the claimed subject matter, from the studies of the drawings, this disclosure and the independent claims. In the claims as well as in the description the word “comprising” does not exclude other elements or steps and the indefinite article “a” or “an” does not exclude a plurality. A single element or another unit may fulfill the functions of several entities or items recited in the claims. The mere fact that certain measures are recited in the mutual different dependent claims does not indicate that a combination of these measures cannot be used in an advantageous implementation.

1. A first access point (110) being configured to:
receive a signal (151) from a terminal (150);
receive data (191) from a network device (190), wherein the data (191) corresponds to a processed form (121) of the signal (151); and
perform a channel estimation based on the obtained signal (151) and the data (191).

2. The first access point (110) according to claim 1, wherein a result of the channel estimation comprises channel response information.

3. A network device (190) being configured to:
obtain data (191), wherein the data (191) corresponds to a processed form (121) of a signal (151) that is transmitted by a terminal (150) and received by one or more second access points (120) for communications; and
send the data (191) to one or more first access points (110) for sensing.

4. The network device (190) according to claim 3, wherein the network device (190) is configured to obtain the data (191) by receiving the data (191) from the one or more second access points, and the data (191) corresponds to a decoded payload (121) of the signal (151).

5. The network device (190) according to claim 3, wherein the network device (190) is configured to obtain the data (191) by:
receiving, from each second access point (120), the signal or a pre-processed signal (121); and
decoding a payload from the signal or the pre-processed signal (121), to obtain the data (191).

6. The network device (190) according to claim 3, wherein the network device (190) is configured to send the data (191) to the one or more first access points (110) by sending a part of the data (191) to the one or more first access points (110) according to one or more of a sensing requirement, traffic information, and a memory constraint of the one or more first access points (110).

7. A method comprising:
obtaining (501), by a network device, data, wherein the data corresponds to a processed form of a signal that is transmitted by a terminal and received by one or more second access points for communications; and
sending (502), by the network device, the data to one or more first access points for sensing.

8. The method according to claim 7, comprising:
obtaining, by a network device, the data by receiving the data from the one or more second access points, and the data corresponds to a decoded payload of the signal.

9. The method according to claim 7, comprising: obtaining, by a network device, the data by:
receiving, from each second access point, the signal or a pre-processed signal; and
decoding a payload from the signal or the pre-processed signal, to obtain the data.

10. The method according to claim 7, comprising: sending, by a network device, the data to the one or more first access points by sending a part of the data to the one or more first access points according to one or more of a sensing requirement, traffic information, and a memory constraint of the one or more first access points.
